(19) United States
(12) Patent Application Publication
(10) Pub. No.: US 2018/0229541 A1
(43) Pub. Date: Aug. 16, 2018

(54) SOUND CONFINING BALL-POINT-PEN

(71) Applicants: Misuzu NAKAO, Tokyo (JP); Shohei Sano, Chiba Pref. (JP); Yuta Suzuki, Tokyo (JP); Shinichiro Yasui, Tokyo (JP)

(72) Inventors: Misuzu NAKAO, Tokyo (JP); Shohei Sano, Chiba Pref. (JP); Yuta Suzuki, Tokyo (JP); Shinichiro Yasui, Tokyo (JP)

(21) Appl. No.: 15/950,205

(22) Filed: Apr. 11, 2018

(51) Int. Cl. B43K 24/08; B43K 7/00; B43K 7/12

(52) U.S. Cl. CPC B43K 24/08; B43K 7/12; B43K 7/005

(57) ABSTRACT

A sound confining ball-point-pen 100 includes a body, which is in vacuum state, having a first opening at one end and a second opening at another end, a knocking mechanism placed in the body at a location close to the second opening, a core of the sound confining ball-point-pen 100 stored in the body, the core being moved by the knocking mechanism, a protective cap, which is fixed to the body, for covering the second opening, whereby the protective cap prevents air for entering into the body from the knocking mechanism, and a sealing means placed in the body at the location close to the first opening for sealing the first opening when the core of is set back into the body.

### BACKGROUND OF THE INVENTION

### 1. Field of the Invention

This invention has been made by the members of MIMURA Seminar, Graduate School of Intellectual Property, Nihon Univ. as a team. The present invention relates to a written instrument, and more particularly to a ball-point-pen, which reduces sound generated at a time of knocking.

### 2. Description of the Related Art

Conventionally, a retractable ball-point-pen, which has knocking mechanism, makes sound of knocking when a core of ball-point-pen returns into its body after using. Because of the using of the spring force, a cam mechanism fixed to the core of ball-point-pen at its rear end hits the fixed cam located in the body so that the knocking sound occurs. This knocking sound resonates in quiet environment and distracts a user and people around the user.

### BRIEF SUMMARY OF THE INVENTION

An objective of the present invention is to resolve the above described problem and to provide a sound confining ball-point-pen 100 having a sealing member and protection cap for holding sound therein. The objective is achieved by a sound confining ball-point-pen 100 having a structure as follows.

A sound confining ball-point-pen 100 includes a body, which is in vacuum state, having a first opening at one end and a second opening at another end, a knocking mechanism placed in the body at a location close to the second opening, a core of the sound confining ball-point-pen 100 stored in the body, the core being moved by the knocking mechanism, a protective cap, which is fixed to the body, for covering the second opening, whereby the protective cap prevents air for entering into the body from the knocking mechanism, and a sealing member placed in the body at the location close to the first opening for sealing the first opening when the core of the ball-point-pen is set back into the body.

### BRIEF DESCRIPTION OF THE DRAWINGS

The invention will be more particularly described with reference to the accompanying drawings, in which:

FIG. 1 is a front view of a ball-point-pen, according to the first preferred embodiments;

FIG. 2 is an enlarged view of the first area 200 illustrated in FIG. 1;

FIG. 3 is an enlarged view of the first sealing member 4a illustrated in FIG. 1;

FIG. 4 is an enlarged view of the third area 400 illustrated in FIG. 1;

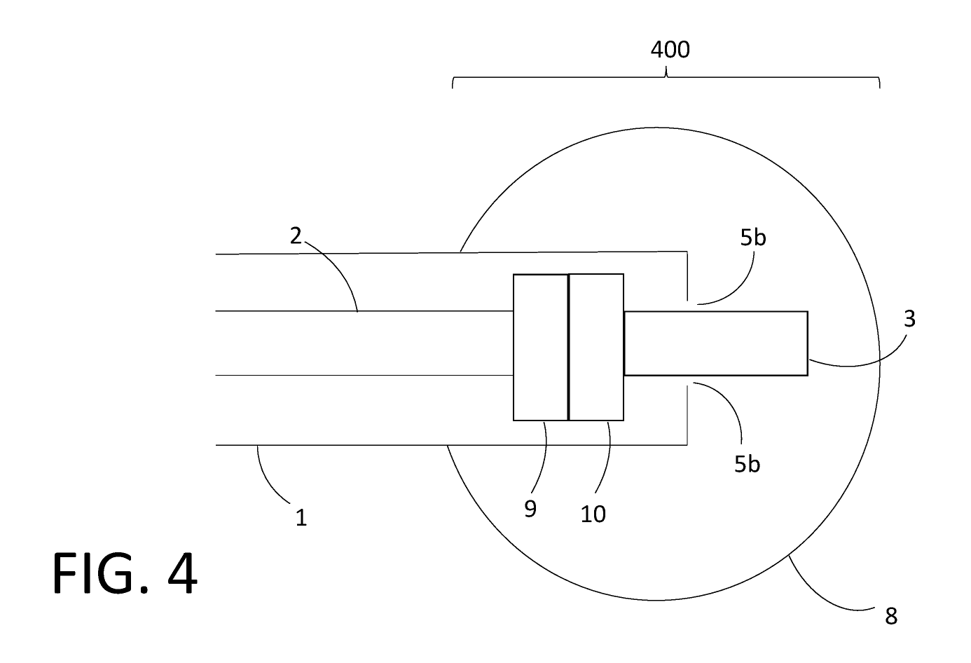

FIG. 5 is an enlarged view of the first area 200 in a projecting mode, wherein a tip 2a of a core 2 of ball-point-pen 100 is pushed out till to its limit;

FIG. 6 is an enlarged view of the third area 400 in the projecting mode;

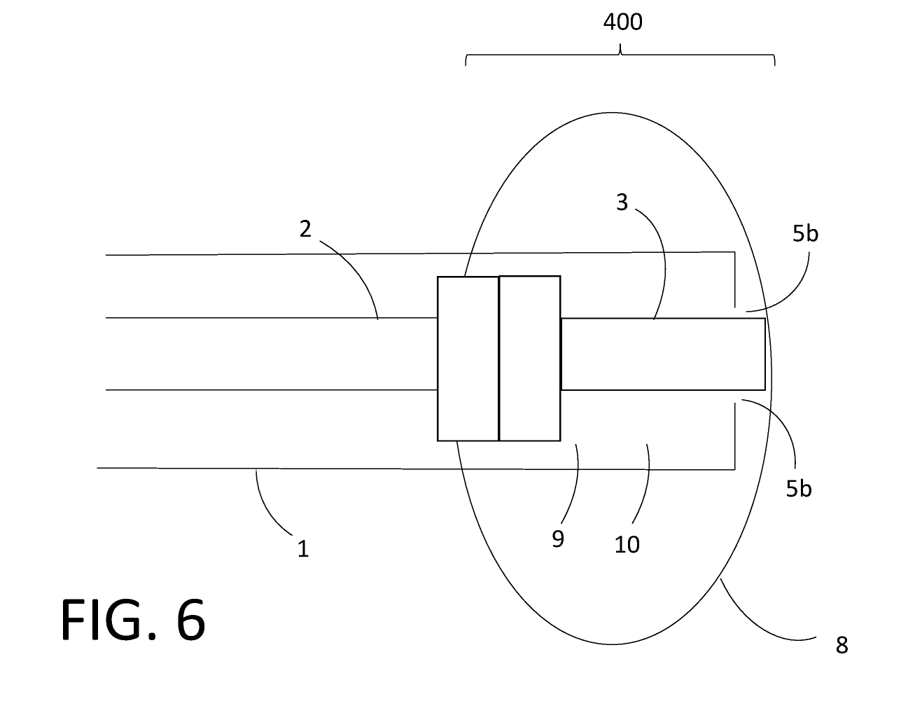

FIG. 7 is an enlarged view of the first area 200 in a stabilizing mode, wherein the pen is ready to write;

FIG. 8 is an enlarged view of the third area 200 in the stabilizing mode;

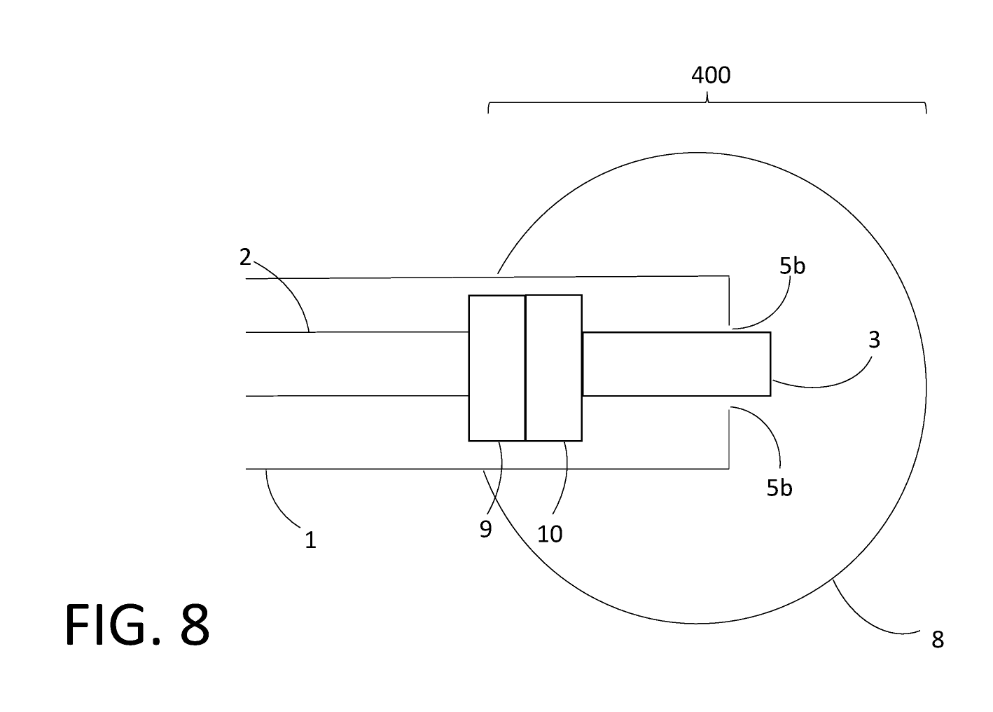

FIG. 9 is a front view of a ball-point-pen of the second preferred embodiment;

FIG. 10 is an enlarged view of the first area 200, according to the second preferred embodiment;

FIG. 11 is an enlarged view of the of the first area 200 in the projecting mode of the second preferred embodiment;

FIG. 12 is an enlarged view of the first area 200 in the stabilizing mode of the second preferred embodiment;

FIG. 13 is a front view of the ball-point-pen, according to the third preferred embodiment;

FIG. 14 is an enlarged view of the second area 300 illustrated in FIG. 13 of the third preferred embodiment;

FIG. 15 is an upper view of the FIG. 14;

FIG. 16 is an enlarged view of the second area 300 in the projecting mode of the third preferred embodiment;

FIG. 17 is an enlarged view of the second area 300 in the stabilizing mode of the third preferred embodiment;

FIG. 18 is a front view of the ball-point-pen, according to the fifth preferred embodiment; and

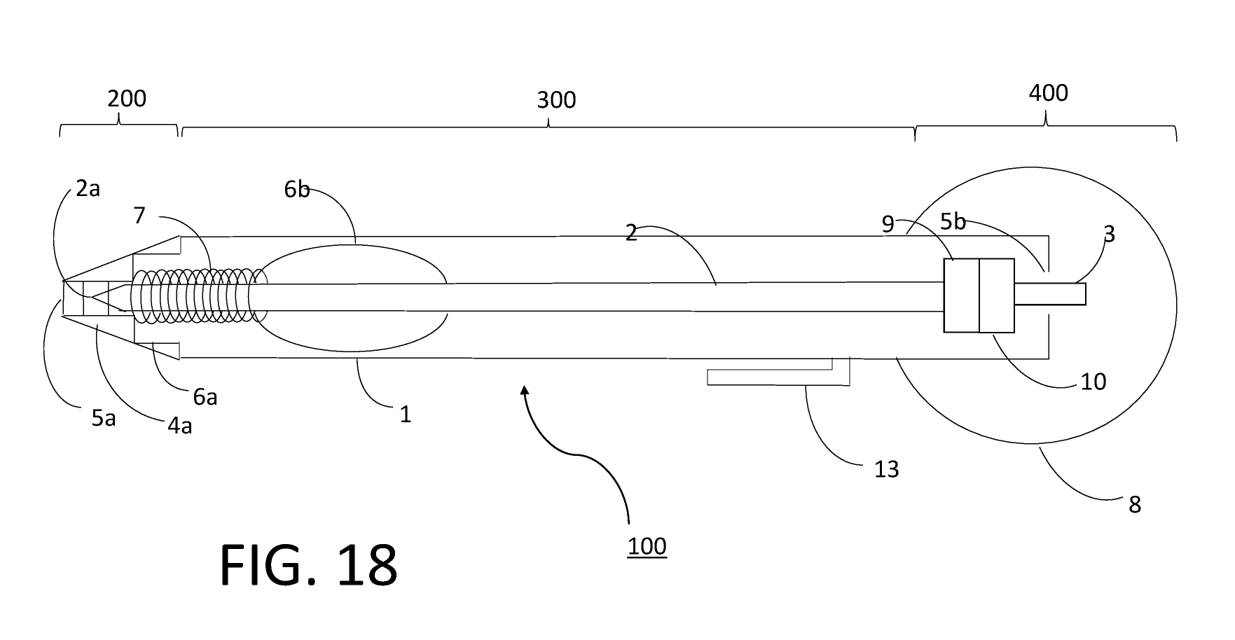

FIG. 19 is a front view of the ball-point-pen, according to the sixth preferred embodiment.

### DETAILED DESCRIPTION OF THE PREFERRED EMBODIMENTS

### First Preferred Embodiment

The preferred embodiment of the invention as to a sound confining ball-point-pen 100 is explained together with drawings as follows. In each drawing, the same reference number designates the same or similar components through all preferred embodiment.

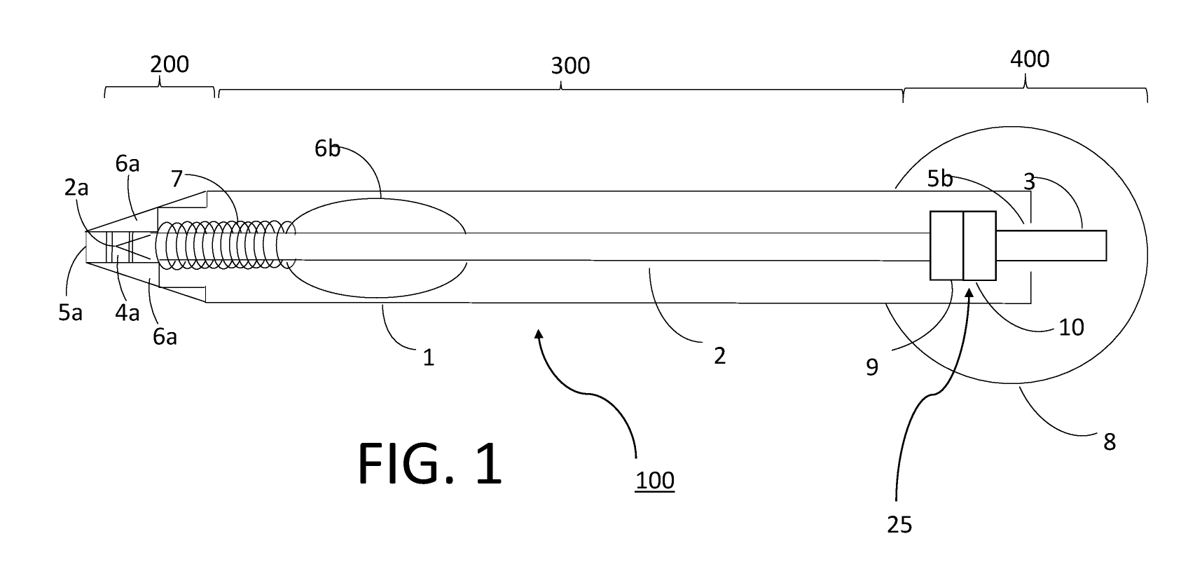

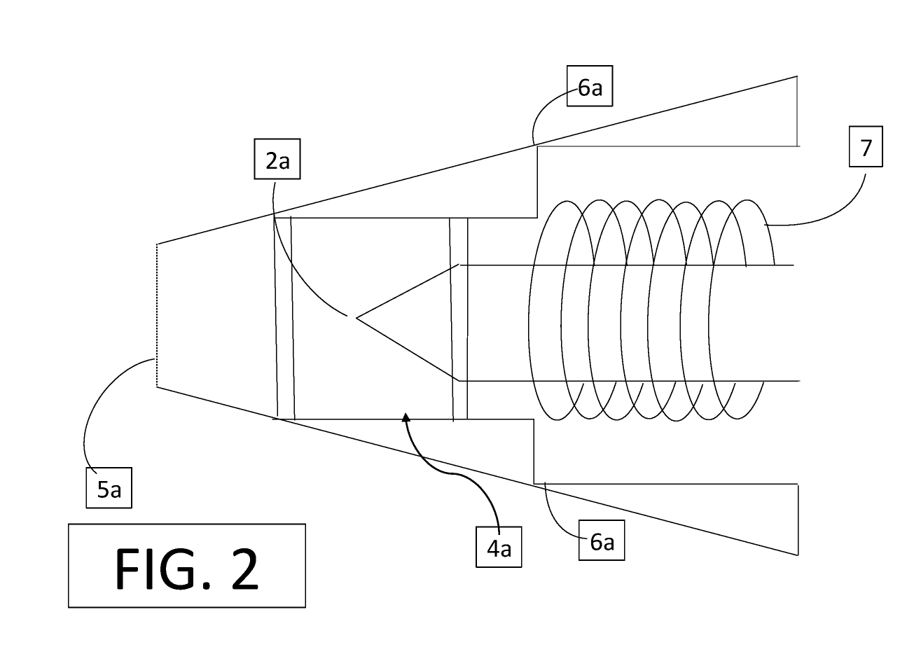

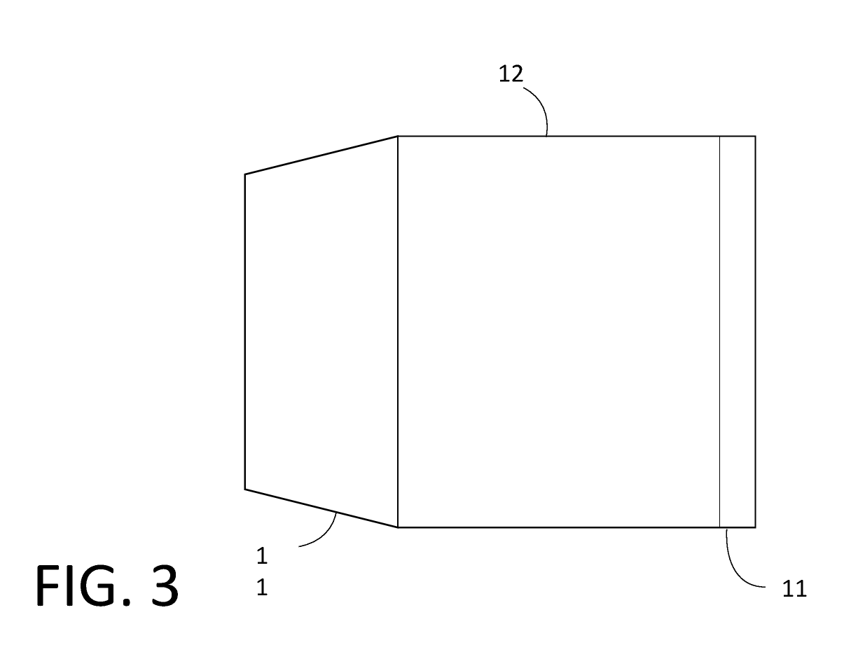

FIG. 1 is the front view of a sound confining ball-point-pen 100 according to the first preferred embodiment of this invention. FIG. 2 is the enlarged view of a first area 200 illustrated in FIG. 1. FIG. 3 is the enlarged view of a third area 400 illustrated in FIG. 1. As shown in FIG. 1, FIG. 2 and FIG. 3, the sound confining ball-point-pen 100 includes a body 1, which has a first opening 5a and a second opening 5b, and a protective cap 8. The protective cap 8 covers the second opening 5b. As referred to FIG. 1, FIG. 2 and FIG. 3, the ball-point-pen has the first area 200, the second area 300 and the third area 400.

The first area 200 is defined as the region starting from the body 1 is tapered and ending at the first opening 5a. The second area 300 is defined as the region starting from the body 1 is tapered and ending at a point where the protective cap is fixed to body 1. The third area 400 is defined as the region where the body 1 is covered with the protective cap 8.

The internal region of the body 1, according to the first preferred embodiment of this invention, is held in a vacuum state. The vacuum state can be performed by manufacturing the body 1 in the vacuumed room. According to the Japanese Industrial Standard, the vacuum level is categorized into five (5); 105 Pa˜102 Pa is categorized in a low vacuum, 102 Pa˜10-1 Pa is categorized in a medium vacuum, 10-1 Pa˜10-5 Pa is categorized in a high vacuum, 10-5 Pa˜10-8 pa is categorized in an ultrahigh vacuum. Preferably, the body 1 is held at the high vacuum level or the above inside. In view of the cost or ease of manufacture, even the body 1 may be made in the room, which is in the lower vacuum level, it can be also expected for the sound confining effect. According to this method, since the vacuumed level of the body 1 can be the same as that in the room, it is easy to control the level in the body 1. Further, it is not necessary to make the body 1 in the vacuumed room in order to make the inside of the body 1 in vacuum state. For example, initially, the ball-point-pen 100 according to the first embodiment can be made in the unvacuumed room, then the air existing in the body 1 can be vacuumed by using a vacuum, then the body 1 is sealed by the protective cap 8. According to alternative method, the level of the vacuum state and the durability of pen's body could be upgraded on the ground for ejecting impurity.

The sound confining ball-point-pen 100 includes a first stopper 6a and a storage 4 where a first sealing member 4a is formed therein in the first area 200. The first stopper 6a is formed on the internal surface of the body 1 in order to holds a spring 7. The storage 4a is formed between the first stopper 6a and the first opening 5a, and its one-end is located adjacent to the first opening 5a. The storage 4 is formed in a frustconical shape. As shown in FIG. 3, the first sealing member 4a is formed by three layers; the first layer 12 is formed with a sealant, and the second and third layers 11 sandwiching the first layer is formed with a super-soft-gel, such as the product manufactured by MASTEC Co. The material used in the first layer 12 has a high fluidity characteristic, and once it exposed to air, it is getting hard, and as a result, it obtains the elastic characteristic.

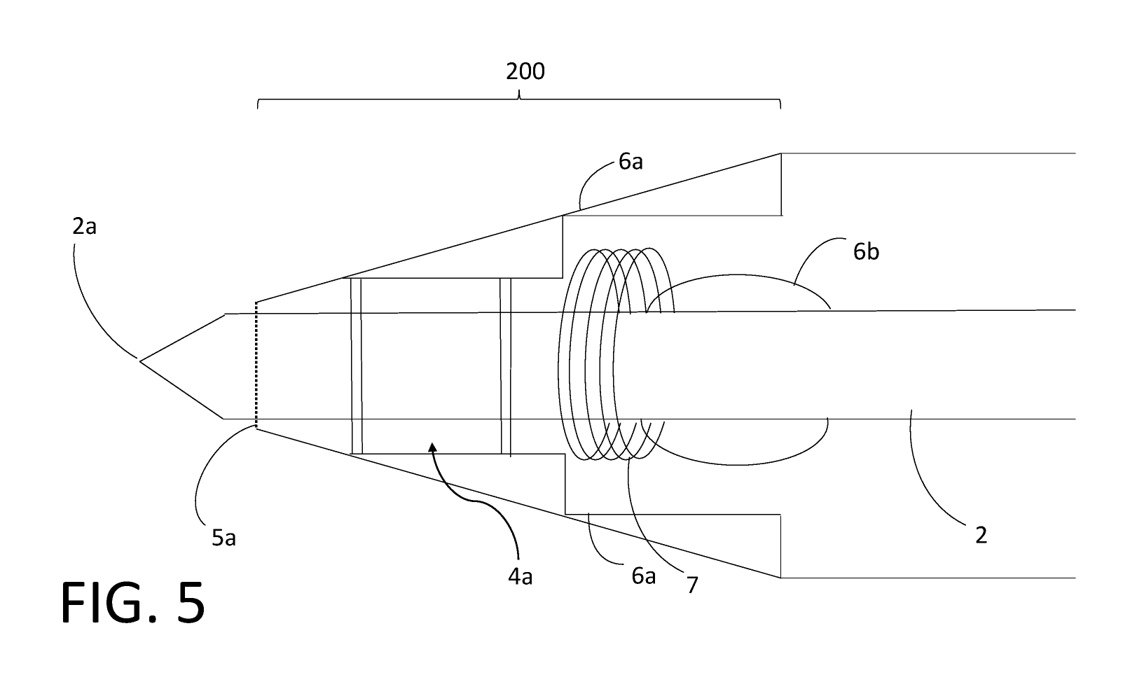

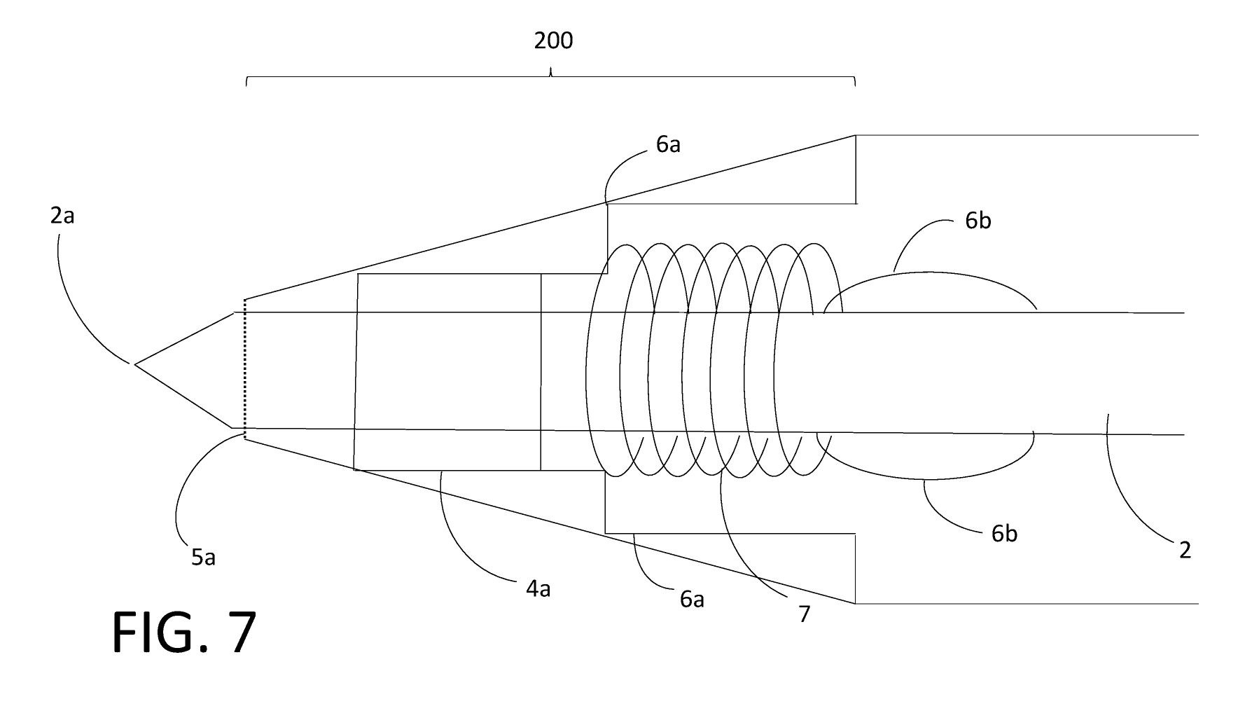

As shown in FIG. 2, FIG. 5 and FIG. 7, the first sealing member 4a maintains the vacuum state in the body 1 even when a tip 2a of the core 2 of the ball-point-pen 100 (hereinafter as refer to “tip 2a”) comes out from the first opening 5a through the first sealing member 4a and when it returns into the body 1. That is why the through-hole formed in the first sealing member 4a made by the tip 2a is self-sealed by flowing the material in the first layer into the through-hole automatically because of the internal and external air pressure differences.

The sound confining ball-point-pen 100 includes the core 2 of the ball-point-pen 100, which contains the ink and the spring 7 in the second area. As mentioned above, the core 2 of ball-point-pen 100 has a tip 2a at the one end and a second stopper 6b on its surface. One end of the spring 7 is coupled with the first stopper 6a located at inner wall surface of the first area 200, and another end is coupled with the second stopper 6b.

The sound confining ball-point-pen 100 includes a knocking member 3 and a cam mechanism 25 for moving the core 2, and the protective cap 8, which covers a second opening 6b located at the other end of the body 1. The cam mechanism 25 includes a rotating cam 9, a fixed cam 10. As well as the conventional ball-point-pen, the tip 2a comes in/out from the first opening 5a in the first area by pressing the knocking member 3. As described above, this structure makes sound by pressing the knocking member 3. However, according to the first embodiment, since the origin of the sound, namely the cam mechanism 25, is concealed with the protective cap 8, the sound could be kept therein and is not leaked.

It is preferable that all of the components except for the tip 2a and the spring 7 are made by the endured for the vacuum stress. The most preferred material is carbon fiber reinforced plastic. The spring 7 is made by metal.

The protective cap 8 covers gaps formed between the body 1 and the knocking member 3 completely to keep the inside of the body 1 being vacuumed. Preferably, the protective cap 3 is made of the elastic material, such as fluorine-contained rubber or polyurethane rubber, in order to transform its shape so that the pressing operation to the knocking member 3 will not be interrupted by the protective cap 8.

This invention is not limited to a ball-point-pen, and it can be used to all the tools for writing or any device if it has a knocking member, which makes a of knocking.

### Second Preferred Embodiment

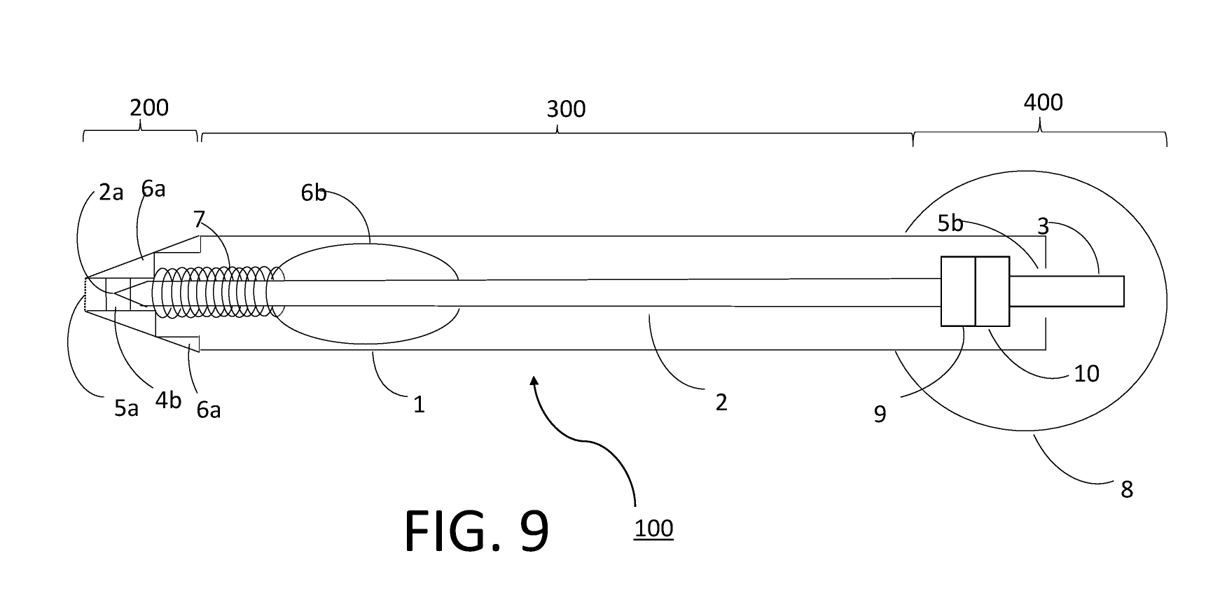

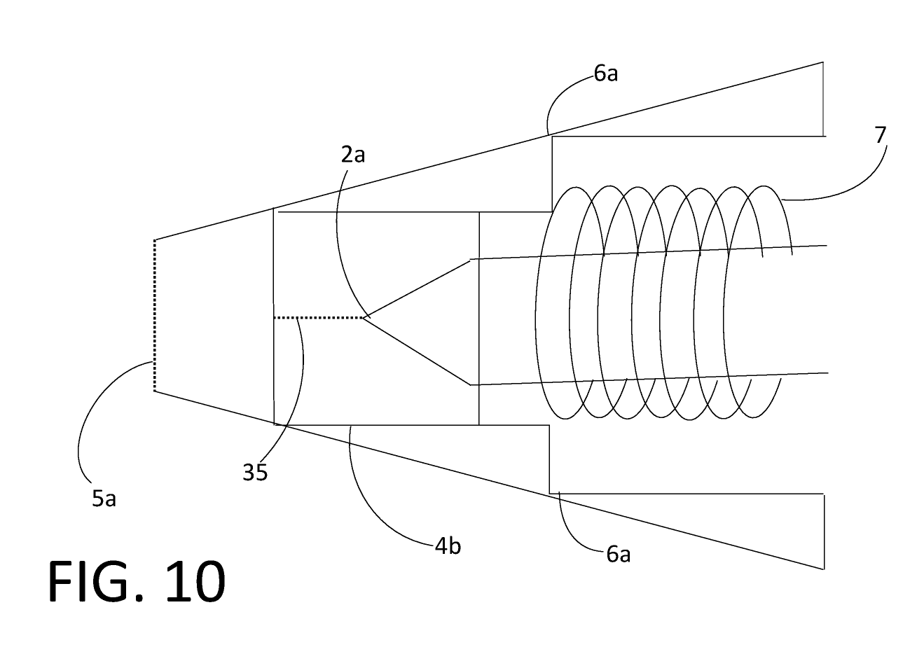

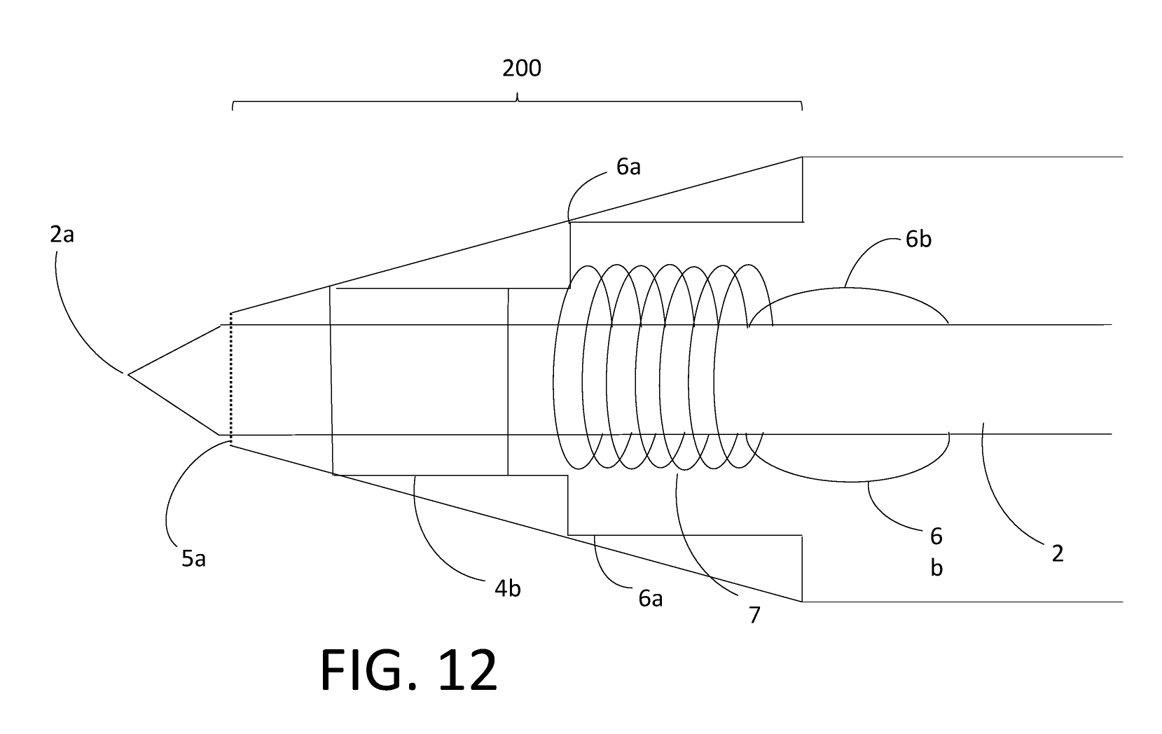

A second preferred embodiment is described in accordance with the FIGS. 9 to 12. All components of the sound confining ball-point-pen 100 of the second embodiment are the same as these used in the sound confining ball-point-pen 100 of the first embodiment, except for the structure of a second sealing member 4b. As clearly shown in FIG. 10, the second sealing member 4b has a through-hole 35 at its center. The diameter of the through-hole 35 is 1 mm less than that of the tip 2a. The one end of the through-hole 35 is plugged with the tip 2a in the stabilizing mode so that the vacuum state of the body 1 is maintained. As for the material of the second sealing member 4b, fluoric resin of the polytetrafluoroethylene that is relatively less dynamic friction coefficient is particularly preferable.

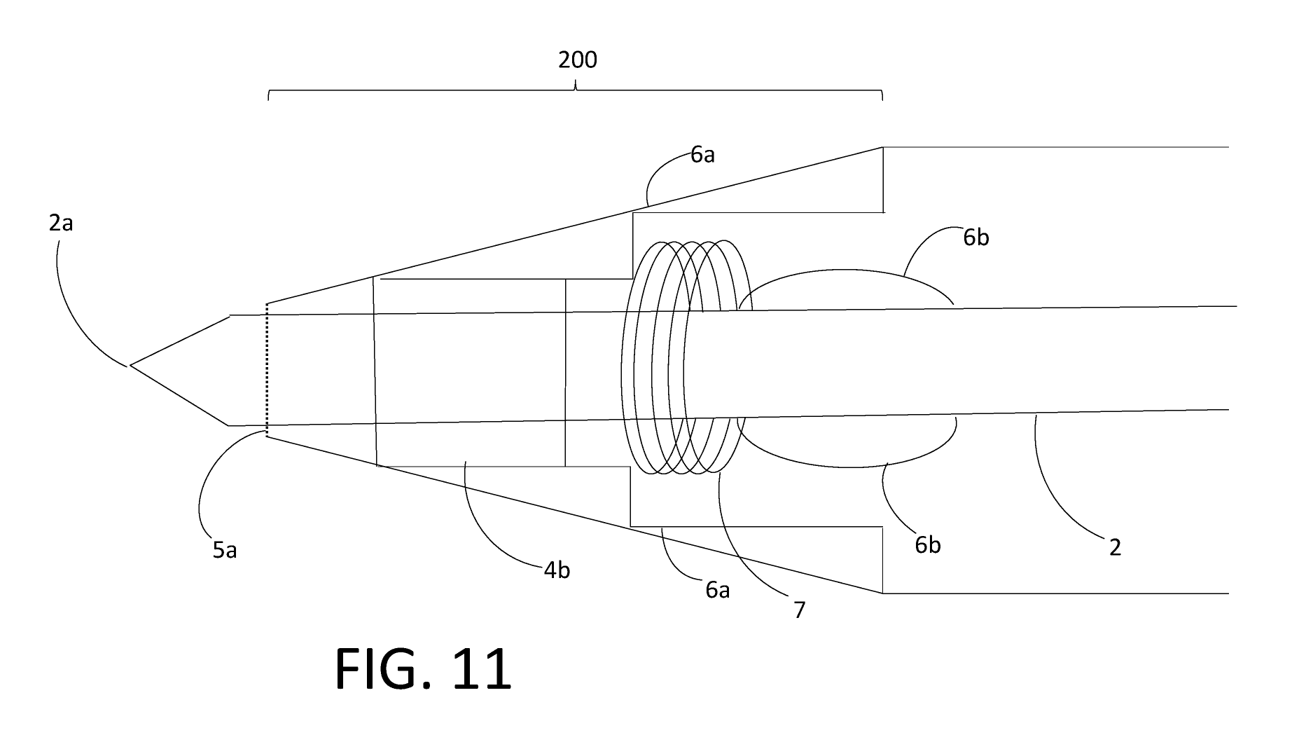

As shown in FIG. 11, the tip 2a jets out of the first opening 5a by transforming the shape of the second sealing member 4b. The pressure occurs between the second sealing member 4b and the tip 2a or the core 2 of the ball-point-pen 100, and the tip 2a or the core 2 of ball-point-pen 100 are always contact with the second sealing member 4b. Therefore, the inside of the body 1 of the ball-point-pen 100 is maintained in a vacuum state at all the time. Compared with the first embodiment, the second sealing means 4b can reduce the consumption of itself, and increase the durability as sealant.

### Third Preferred Embodiment

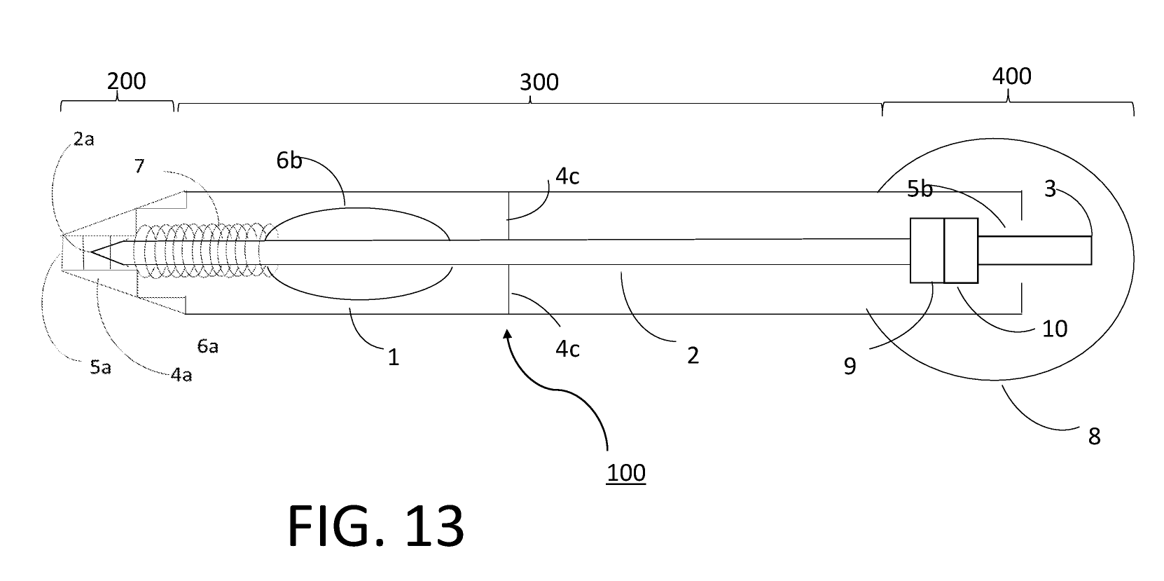

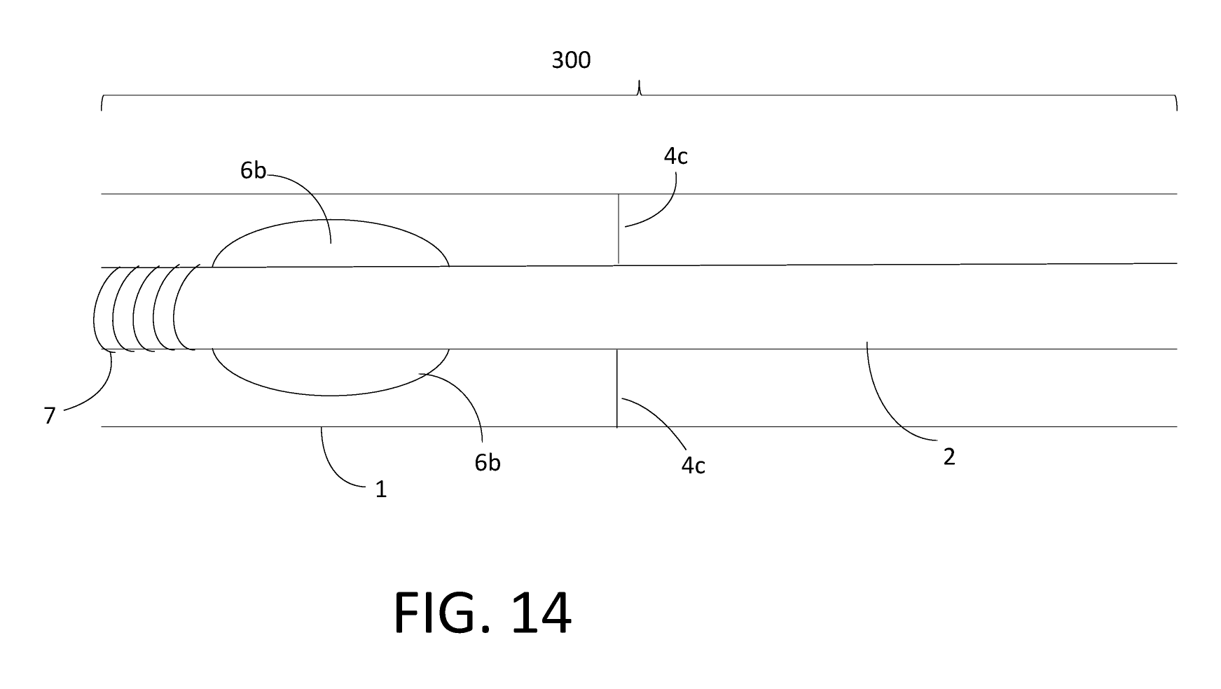

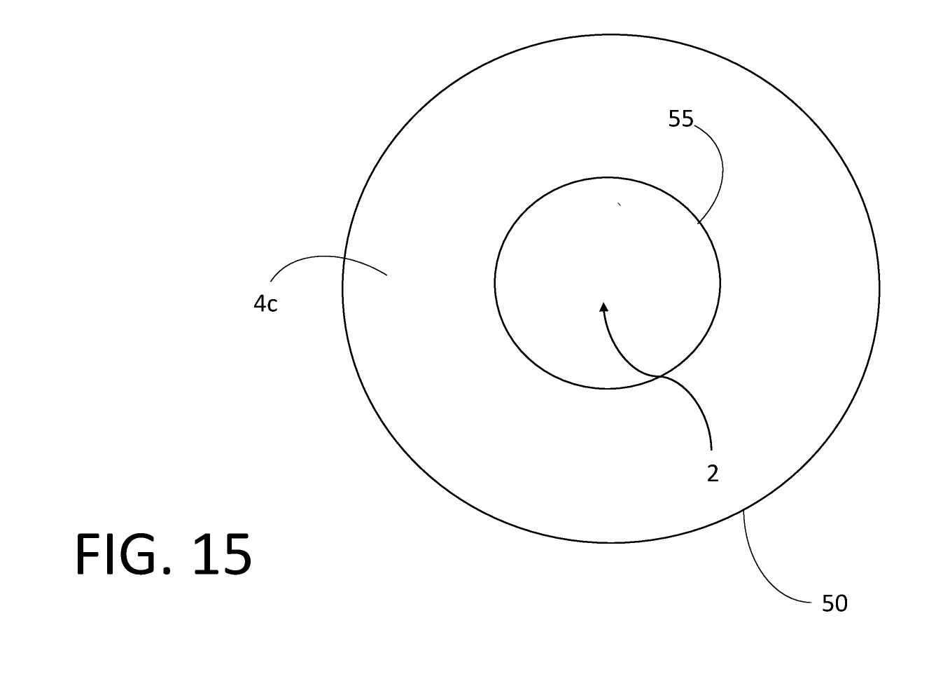

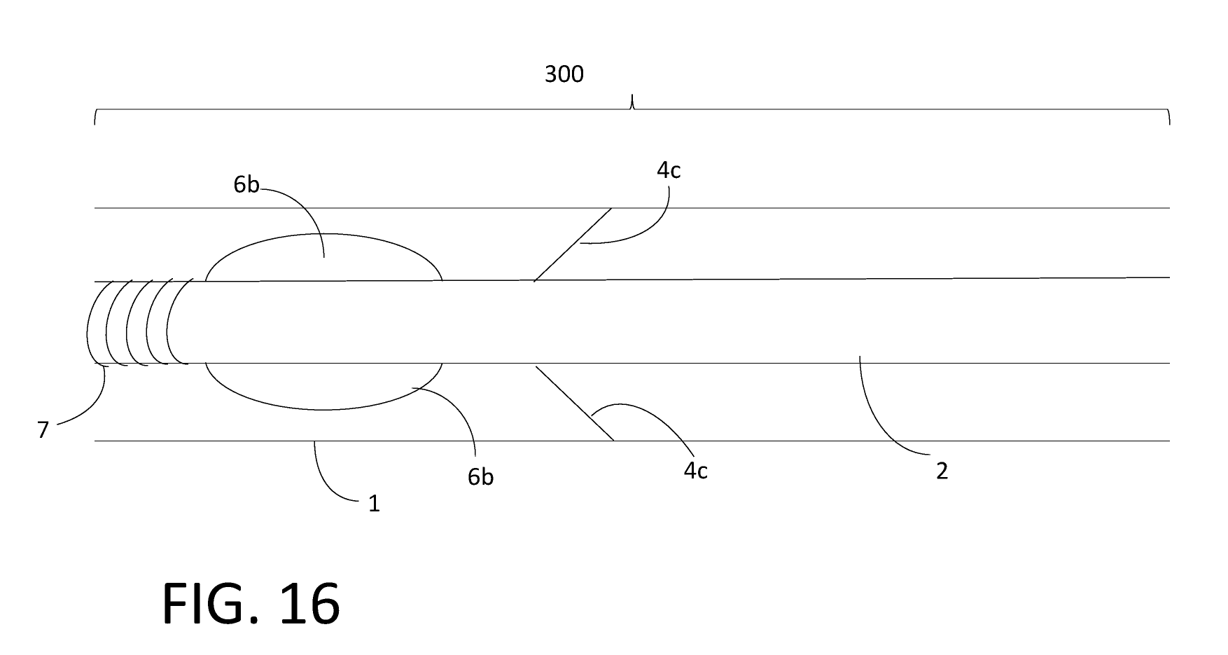

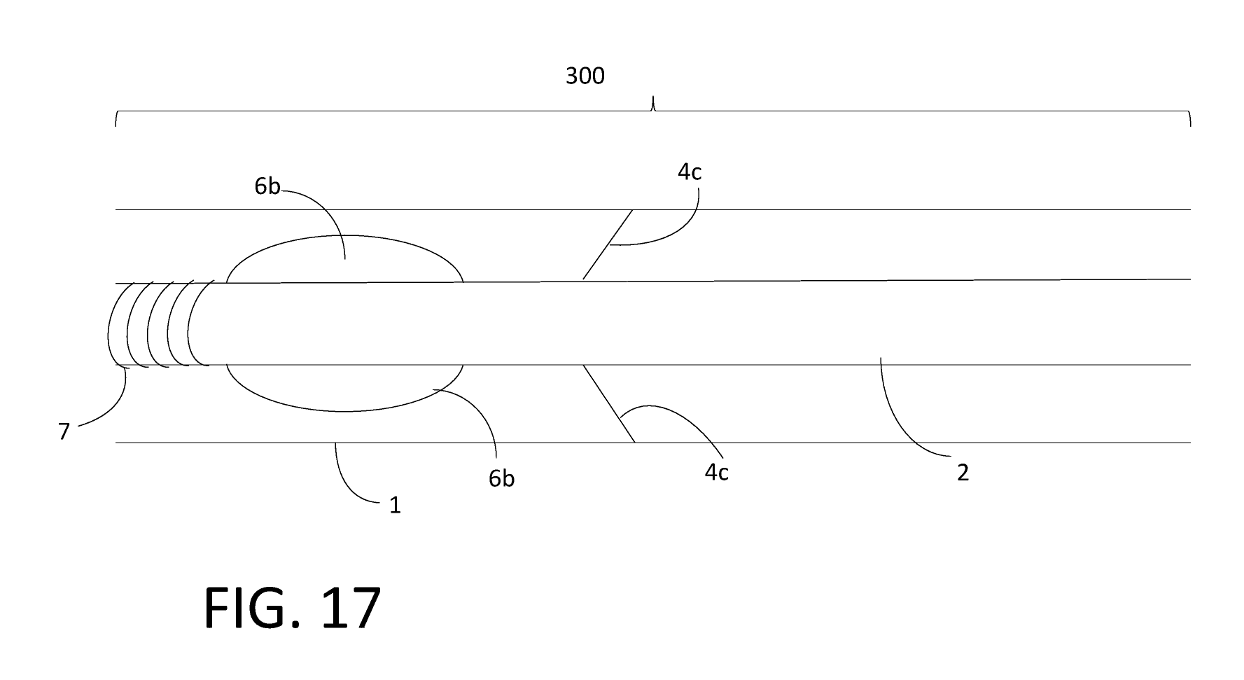

A third preferred embodiment is described in accordance with the FIGS. 13 to 17. As shown in these drawings, the sound confining ball-point-pen 100 of the third embodiment includes a third sealing member 4c instead of the second sealing member 4b used in the second embodiment. The third sealing member 4c is donut-shaped; its outer periphery 50 is united with the inner wall of the body 1 of the ball-point pen, and its inner periphery 55 is united with the outer surface of the core 2 of the ball-point-pen 100. The sealing member 4c is formed by a rickrack structure and, thus it keeps the vacuum state in the body 1 even the core is moved forward and back. That is why the third sealing member 4c can be elongated and contracted along the movement of the core 2 of the ball-point-pen. The third sealing member 4c is formed in the second area 300. According to the structure as described above, it is possible to separate the first area 200 from the second area 300 so that the maintenance would become much easier. The third sealing member 4c is made of a rubber. Alternatively, as the material, a fluorine rubber or urethane rubber having high durability characteristic is particularly preferable to endure from the external air pressure.

### Fourth Preferred Embodiment

In addition to the first through third preferred embodiments, forming the body 1 with transparent material, such as reinforced plastic, makes it possible to check the color of ink or the remaining amount of ink in the core 2 of the ball-point-pen 100. In addition, if the impurities are mixed into the body 1, and it is possible to fined losing of the vacuumed condition at the early stage. In addition to the benefit as described above, by injecting water into the body 1 being vacuumed under 2.3 kPa, the water stored therein will be vaporized over 20 Celsius in outer air. Thus, it is possible for the user to watch the changes based on air temperature, in addition to noise reduction effect. The transformation structure of water has effects of informing the user of malfunction, for example change of atmospheric pressure.

### Fifth Preferred Embodiment

In addition to the preferred embodiment, the clip 13 installed in the third area 400 of the ball-point-pen 100 is able to be installed on the side surface of the main body 1. This ball-point-pen is able to fix a pocket of cloth or a book, by having a part of clip 13 fitted on this ball-point-pen 100. As this ball-point-pen 100 inadvertently contact with another object and the main body 1 is damaged, it helps to reduce the possibility of losing the vacuum function. The clip 13 portion may be fixed to the main body 1 or may be added later as an independent part.

### Sixth Preferred Embodiment

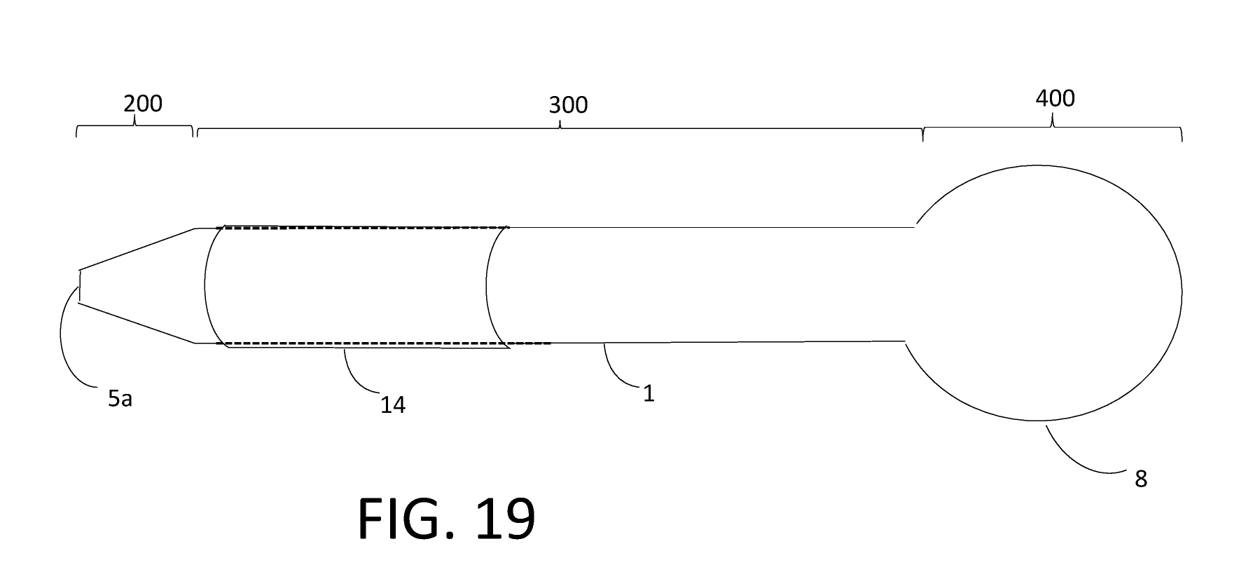

In addition to the first through third preferred embodiments, as shown in FIG. 19, a 14, which is made of shock confining material, is formed on the surface of the body 1 in the second area 300 to reduce the fatigue of the hand and to confine shock when dropped. The length of the grip 14 is set within the range between from 1 cm and the length of the second area 300.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description. Therefore, the appended claims are intended to cover any such modifications or embodiments as fall within the true scope of the invention

We claim:

1. A sound confining writing instrument, comprising:
a body, which is in vacuum state, having a first opening at one end and a second opening at another end,
a knocking mechanism placed in the body at a location close to the second opening,
a core of the sound confining writing instrument stored in the body, the core being moved by the knocking mechanism;
a protective cap, which is fixed to the body, for covering the second opening, whereby the protective cap prevents air for entering into the body from the knocking mechanism; and
a sealing means placed in the body at the location close to the first opening for sealing the first opening when the core is set back into the body.

2. A writing instrument as claimed in claim 1, wherein the sealing member is formed in the three layers, wherein the middle layer is formed of fluid sealant.

3. A writing instrument as claimed in claim 1, wherein the sealing member is formed in a single integral structure having a through-hole in its center, which is generally closed by the pressure of the martial of the sealing member.

4. A writing instrument as claimed in claim 1, wherein the sealing means is a sealing member which is located that first area, the first area is defined as an area starting from a location that the body 1 tapered, to the one-end opening.

5. A writing instrument as claimed in claim 1, wherein the shape of sealing means is identical with the body shape of the formation location.

6. A writing instrument as claimed in claim 2, wherein the shape of sealing means is identical with the body shape of the formation location.

7. A writing instrument as claimed in claim 3, wherein the shape of sealing means is identical with the body shape of the formation location.

8. A writing instrument as claimed in claim 1, wherein, the body is made with the carbon fiber reinforced plastic.

9. A carbon fiber reinforced plastic as claimed in claim 8, it is transparent.

10. A writing instrument as claimed in claim 1, wherein the sealing member is donut-shaped, and wherein its outer periphery is united with the inner wall of the body, and its outer periphery is united with the outer surface of the core.

11. A writing instrument as claimed in claim 1, wherein the sealing member is formed of plastic.
